(19) United States
(12) Patent Application Publication
(10) Pub. No.: US 2003/0148254 A1
(43) Pub. Date: Aug. 7, 2003

(54) Method and apparatus for interactive learning in a group environment

(76) Inventor: Isadora Arzu, Katy, TX (US)

Correspondence Address: Darcell Walker, Suite 250, 9301 Southwest Freeway, Houston, TX, 77074, US

(21) Appl. No.: 10/356,128

(22) Filed: Feb. 1, 2003

Related U.S. Application Data
(60) Provisional application No. 60/353,246, filed on Feb. 1, 2002.

(51) Int. Cl. G09B 3/00

(52) U.S. Cl. 434/322

(57) ABSTRACT

The present invention is a tool for enhancing interest in and memory retention of visual alphanumeric text messages and images that are readable both as conventional two-dimensional printed text messages and as perceived three-dimensional text and images. This tool is a hand-held article that comprises a clear pocket capable of receiving inserted materials and displaying the inserted concept or information that a teacher wants to convey to the students. The student can continually view and recite the inserted information as part of the retention process for learning the material. Because of the shape and composition of the present invention, it can be used as a recreational device. The article can be passed between students as the students recite the information contained in the window pocket. The repetition of the chants serves to reinforce the retention of the chanted information.

### CROSS-REFERENCE TO RELATED APPLICATIONS

This application claims priority from a provisional application number 60/353246 filed on Feb. 1, 2002, the contents of which are incorporated herein by reference.

### FIELD OF THE INVENTION

This application relates to a method, apparatus and system for teaching and in particular to a method, apparatus and system for teaching groups of participants interactively through a series of exercises and games.

### BACKGROUND OF THE INVENTION

It is an established fact that not everybody learns in the same manner. Some people learn better visually, others learn better audibly, still other students learn better through participation in exercises that require the person to do or perform some activity. Because of the various ways that students learn, teachers have a plurality of techniques that they implement based on the learning habits of the students.

In the act of teaching, there are two parties (the teacher and the taught) who work together in some program (the subject matter) designed to modify the learner's behavior and experience in some way.

Teachers must face the problem of how to maintain curiosity and interest as the chief motivative forces behind the forces behind the learning. Sustained interest leads the student to set himself realistic standards of achievement. Vital intrinsic motivation may sometimes be supplemented by extrinsic rewards and standards originating from sources other than the student himself, such as examinations and outside incentives, but these latter are better regarded as props to support the attention of the learner and to augment his interest in the subject matter.

At the end of the lesson proper or of any other unit or program of instruction, the teacher must assess its results before moving to the next cycle of teaching events. Assuming the occurrence of teaching-learning cycles of instruction-construction activity, it follows that there is a built-in process of frequent assessment during the process of any period of teaching. The results of the small phases of the learner's problem solving provide at the same time both the assessment of past progress and the readiness for further development.

In general, educators see instructional media as aids rather than substitutions for the teacher. A teacher spends a disproportionate amount of their time in routine chores such as collecting and assigning books and materials and in marking papers. This time could be partly obviated if aids could be so constructed as to free the teacher to concentrate on the central job of promoting understanding, intellectual curiosity, and creative activity in the learner.

In lectures and recordings, the teacher is able to set out their material as they think best, but usually the audience reception is passive since there is not much opportunity fir a two-way communication of ideas. Furthermore, in lectures, much of the student's energies may be taken up with note writing. This situation inhibits thinking about the material. Recordings enable one to store lecture material and to use it on occasions when a teacher is not available, but they are rather detached for young learners and seem to evoke better results with older students.

Language laboratories are study rooms equipped with electronic sound-reproduction devices, enabling students to hear model pronunciations of foreign languages and to record and hear their own voices as they engage in pattern drills. Most laboratories provide a master control board that permits a teacher to listen to and correct any student individually. Many are equipped to use filmstrips or motion pictures simultaneously with the tape recorders. These laboratories are effective modes of operant learning, and after a minimum vocabulary and syntax have been established, the learning can be converted into a stimulating form of problem solving.

Visual and observation media are another critical device used in teaching. Visual aid materials include objects and models, diagrams, charts, graphs, cartoons, and posters; maps, globes, sand tables for illustrating topographical items; pictures, slides filmstrips, motion pictures and television. Activities as field trips and the use of visiting authorities (usually called resource people) are also considered part of visual and observational programs, and even demonstrations, dramatizations, experiments, and creative activities are usually included.

In general, pictures and diagrams, field trips, and contrived experiments and observations are all used as concrete leads to the generalizing, abstracting, and explaining that constitute human learning. To fulfill this function, however, their use must be accompanied by interpretation by an adult mind.

The teacher must offer careful elaboration and discussion for children's and adolescents' powers to interpret and infer often go astray and thus must be carefully guided. Visual material by itself may even be a hindrance; a scattering of pretty pictures through a history text, for example, does not necessarily produce a better understanding of history. Similar difficulties are inherent in fieldwork (geographical, biographical, archaeological and geological. What is observed rarely gives the whole story and in the case of archaeological and geological fieldwork, provides an incomplete picture of the past. The teacher must fill in the gaps or somehow lead his students to do so.

Reading and writing media have also formed the staple of traditional education. This media aids in the communication between a teacher and a reader. The material in a textbook is a sample of a subject area, simplified to a level suitable for the reader. Programmed learning is a newer form of reading and writing. The most basic form of programmed instruction, called linear programming, analyzes a subject into its component parts and arranges the parts in sequential learning order. At each step in a student's reading, the student is required to make a response and is told immediately whether or not the response is correct. The program is usually structured so that right answers are apt to be extremely frequent (perhaps 95 percent of the time), in order so that theory goes, to encourage the student and give him a feeling of success. In another kind of programmed instruction, called branching programming, the student is given a piece of information, provided with alternative answers to questions, and, on the basis of his decision, detoured, if necessary, to remedial study or sent on to the next section of the program. The two types of programs differ fundamentally in their attitudes toward errors and the use of them. The brancher uses them to further the learning; the linearist avoids them. The chief value of programmed instruction in general is that it allows a student to learn at this own pace, without much teacher supervision. Its chief defect is that it can quickly become dull and mechanical for the student.

Computer-based instruction comprises another tool used to convey information to students such that the student a large portion of the information. The large storage and calculating capabilities of the computer suggest potential for its use in the classroom. It can give instructions to the student, call for responses, feed back the results, and modify his further learning accordingly. The computer can also be used to measure each student's attainments, compare them with past performances, and then advise teachers on what parts of the curriculum they should follow next.

In a fully computer-assisted instruction program, the computer takes over from the teacher in providing the learner with drill, practice, and revision, as well as testing and diagnosis. The form of the teaching may be simply linear or branching, or it can be extended to thinking and problem solving by simulation. The limitations at the moment for computer-assisted instruction are in the area of a student's responses. These responses are limited to a prescribed set of multiple choices. Free, creative responses, which one associates with the best of classroom situations, cannot yet be accommodated.

All other varied techniques and tools that are available for use in learning environments illustrate that no one method of teaching is sufficient for all students. Because of the scrutinization of the educational systems under today and the demand for accountability in the classroom, there is enormous pressure teachers and other educators to produce results in the classroom. In addition, limited resources often make this task virtually impossible. One way to address this situation is with clever teaching techniques that enable students to grasp information in a manner such that the information is comprehended and retained for a longer period of time.

Therefore, there remains a need for teaching techniques that make the process of learning more interesting and exciting. There also remains a need for teaching techniques that create an enjoyable learning atmosphere that encourages and motivates students to do their best.

### SUMMARY OF THE INVENTION

An objective of the present invention is to provide an instructional and teaching tool and material that makes the learning process more enjoyable and productive.

It is a second objective of the present invention to a visual aided learning tool and material.

It is a third objective of the present invention to provide a learning tool and material that requires a hands-on activity by the students.

It is a fourth objective of the present invention to provide a learning activity that enables students to learn through repetitive activities.

It is a fifth objective of the present invention to provide a teaching tool that re-enforces the materials disclosed to a student during a teaching session.

It is a sixth objective of the present invention to provide a tool and activity that could enable participants to develop the ability to work with other participants.

The present invention is an instructional device and material that has a multipurpose use. It is used as an instructional material for classes such as math, language arts, foreign languages, science, social studies etc.

The present invention is also used to facilitate a variety of instructional strategies such as, role-play and games, and simulation. It facilitates learning giving students the opportunity to learn from each other in a cooperative learning environment. In addition, the present invention incorporates instructional strategies designed to allow students to learn through their experiences in the process of learning.

The present invention is a tool for enhancing interest in and memory retention of visual alphanumeric text messages and images that are readable both as conventional two-dimensional printed text messages and as perceived three-dimensional text and images. This tool is a hand-held article that comprises a clear pocket capable of receiving inserted materials and displaying the inserted concept or information that a teacher wants to convey to the students. The student can continually view and recite the inserted information as part of the retention process for learning the material. Because of the shape and composition of the present invention, it can be used as a recreational device. The article known can be passed between students as the students recite the information contained in the window pocket. The repetition of the chants serves to reinforce the retention of the chanted information.

### DESCRIPTION OF THE DRAWINGS

FIG. 1 is a front view of the article of the present invention showing the pocket window containing inserted information to be retained by the students.

FIG. 2 is a front view of an alternate embodiment of the article of the present invention showing the pocket window containing inserted information to be retained by the students.

FIG. 3 is an illustration of the type of information inserted into the pocket window of the present invention to facilitate teaching a student how to determine the time of day.

FIG. 4 is an illustration of a type of mathematical equation inserted into the pocket window of the present invention to facilitate teaching student multiplication.

FIG. 5 is an illustration of a type of science information inserted into the pocket window of the present invention.

FIG. 6 is an illustration of a type of social studies information inserted into the pocket window of the present invention to teach students the states.

FIG. 7 is flow diagram of the steps in a learning activity incorporating the article of the present invention.

### DETAILED DESCRIPTION OF THE INVENTION

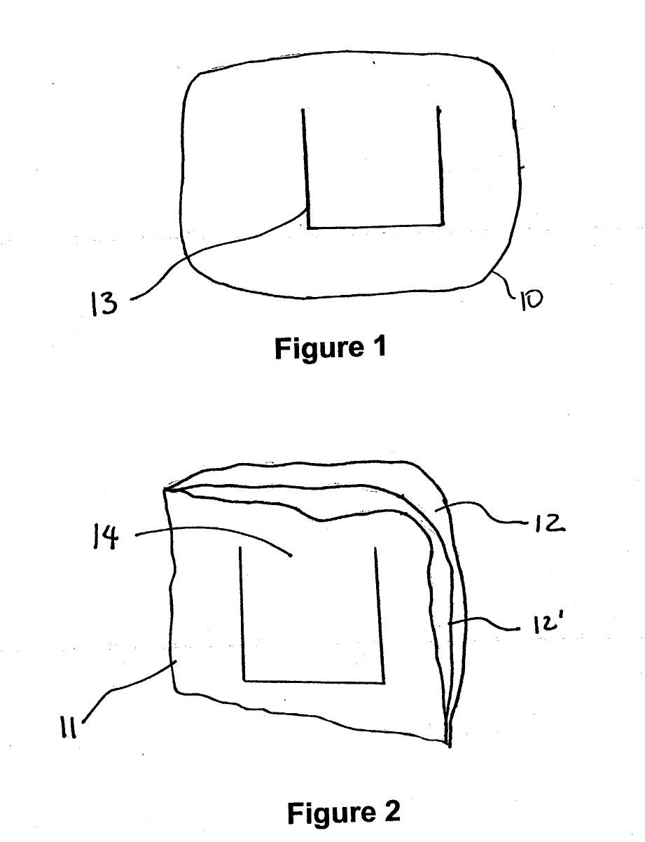

The present invention as shown in FIG. 1 comprises a container member 10 made of a flexible and malleable material. This material would preferably be a cloth type material. However, other materials with similar characteristics would also be appropriate. Another design for this container member 10 could comprise two pieces of this soft and flexible material as shown in FIG. 2. These two pieces 11 and 12 could be attached at their edges to form the container member. Thread or some adhesive material 12′ could be used to attach the edges 11 and 12. This container member 10 is filled with a soft material. This material could be material such as sand, cotton, or rosin. Attached to the outer surface of the container member is clear and transparent material such as a plastic 13. This attachment of this material forms a window on the container member. The transparent material 13 can have various shapes, however it is also attached such that a portion of the transparent member is open to form a pocket on the container member 10. The opening portion 14 of the window pocket 13 is to facilitate the insertion of images into the pocket. The transparent characteristic enables students to easily see the inserted images or other information that is to be learned by the student. The contact member 10 can also have an additional pocket opposite the window pocket 13. This second pocket can be larger than the window pocket and can allow for storing of multiple cards. In this way the pocket window would not need to be used to display and store cards.

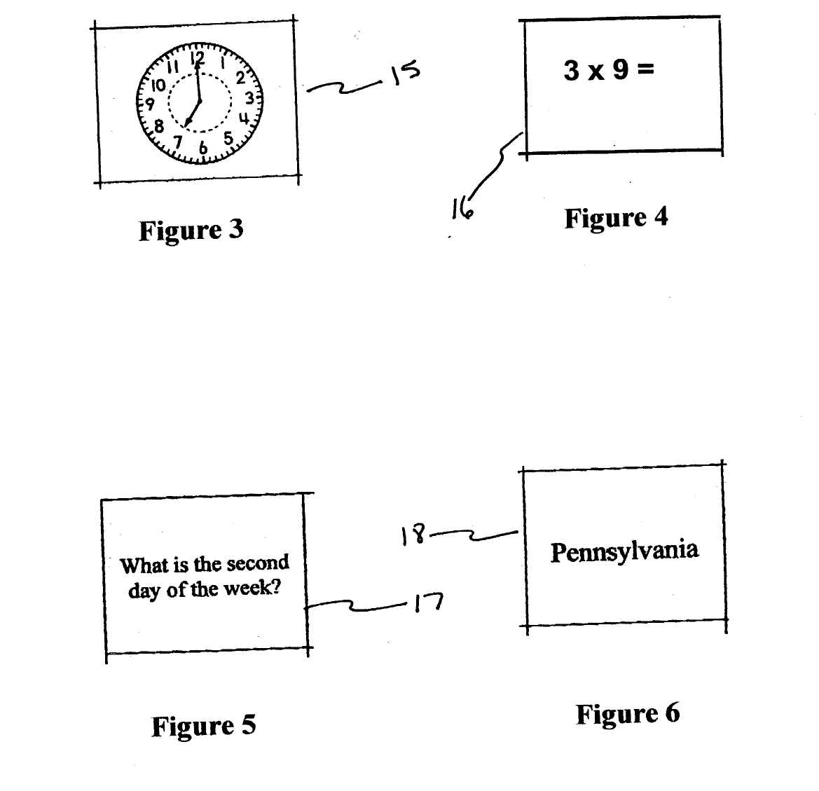

FIGS. 3, 4, 5 and 6 show a plurality of cards containing information from various subjects that is to be learned by students. FIG. 3 shows a plurality of cards 15 displaying various times. These cards will assist in the process of helping students learn how to determine the time of day. FIG. 4 shows a plurality of cards 16 that can display various mathematical equations. In the present illustration, the cards contain multiplication equations. FIG. 5 displays cards 17 containing science information. FIG. 6 displays cards 18 containing social studies information. The display cards could have a rigid characteristic or these cards could be flexible in nature. In addition, the shape of the cards should be consistent with the shape of the pocket window 13.

As previously described, the present invention is used the teaching process. The present incorporates concepts from the children's game traditionally known as “Hot Potato”. In this game, each player possessed a number of cards. In the process of playing the game, players passed around a potato during a defined interval of time. The objective of the game was to not have the potato at the end of the interval of time. The player holding the game at the end of the interval lost one of their cards. When a player lost all of their cards, that player was out of the game. The last player with cards was the winner of the game.

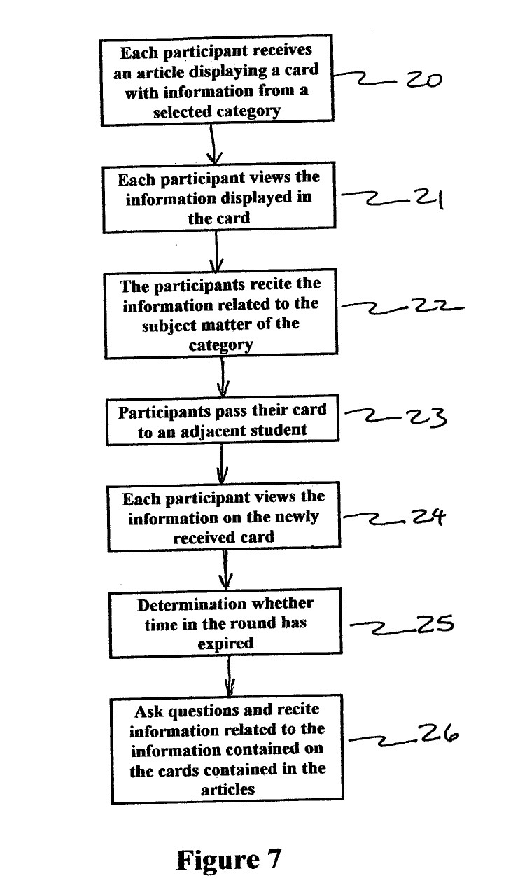

FIG. 7 illustrates the steps involved in using the present invention in to teach various types of information to students. In practice, a primary application for this method is the re-enforce materials presented to students during and after a teaching session. Prior to the beginning of the activity, cards such as those in FIGS. 15, 16, 17 or 18 can be placed in the articles. The participants are positioned in a circular arrangement such that each participant has persons on both sides. In step 20, a participant receives an article of the present invention containing the cards. Each article can have one or more cards in the plastic window containing information such as questions, pictures, or statements on the particular subject in review. The content of the top card is displayed in the pocket window of the article. Each card in each article's window contains a different question related to the same subject matter. In step 21, each participant views the information on the top card of his/her article.

The activity of the present invention is implemented in rounds. The length of a round will be established prior to the start of the activity. In step 22 at the start of the activity, the participants begin to recite or chant a rhythmical phrase or song related to the subject matter. In a classroom, the participants could chant topics such a states and capitols, prime numbers, or the planets. In a Bible class, they could chant the lists such as the books of the New Testament. In step 23, as the participants chant, simultaneously, they pass the article to the person one side, depending on the direction. In addition, they receive another article from the person on their other side around the circle. During this time, excitement grows as the participants gain speed in passing the articles. As each student receives a new article, in step 24 each participant reads/views the information or question on his/her new card and questions the question. The card that a participant started with will end up with another participant at the end of each round. In other words, at the end of each round each participant will end up with a different question.

During the activity, step 25 is where the time remaining in the activity is checked to determine if there is any time remaining in the round of the activity. If there is still time in the round, the activity continues at either step 21 or 22. When time expires, in step 26, the participants are asked questions based on the information contained on the display cards and the chants. The repetition of the chants serves to reinforce the retention of the chanted information. The student can repeat information related to the inserted information and thereby reinforcing the learning of the material or information. Because of the shape and composition of the present invention, it can be used as a recreational device.

The present invention provides several benefits. Some of the benefits of activities associated with the present invention are:

This invention is an excellent tool for an icebreaker activity or to get persons acquainted with each other.

The application of the tools and techniques of the present invention can be used in many different settings such as workshops, seminars or Bible classes.

This invention keeps students interested and motivated

This invention encourages student communication free of anxiety when it comes to learning a foreign language.

This invention promotes a cooperative learning atmosphere

The activities associated with the invention are interactive and realistic

This invention helps create a supportive learning environment.

This invention helps to diminish a student's anxiety and promotes active participation in the process of learning.

This invention helps a student maintain his or her attention.

This invention facilitates social interaction

This invention helps student explore student creativity and leadership

As mentioned, the present invention has applications in other areas in addition to the convention classroom setting. This invention has application in corporation environments when it is important to teach persons how to work in teams. The interactive learning activities could be used to help team members become better acquainted with each other. In addition, this invention has applications in any setting where there will group interaction in an attempt to convey and retain certain information.

The apparatus and methods of this invention provide significant advantages over the current art. The invention has been described in connection with its preferred embodiments. However, it is not limited thereto. Changes, variations and modifications to the basic design may be made without departing from the inventive concepts in this invention. In addition, these changes, variations and modifications would be obvious to those skilled in the art having the benefit of the foregoing teachings. All such changes, variations and modifications are intended to be within the scope of this invention.

I claim:

1. An article for use in the process of re-enforcing information presented in an interactive learning environment comprising:
a container member having an exterior surface;
a soft material within said container member;
a transparent material attached to the exterior surface of said container member; and
an information card positioned in said transparent member such that information contained on the card is displayed through said transparent material.

2. The article as described in claim 1 wherein said container member comprises a flexible and malleable material.

3. The article as described in claim 1 wherein said container member further comprises material attached to said container member for sealing said soft material in said container member.

4. The article as described in claim 3 wherein said attached material is thread.

5. The article as described in claim 1 wherein said soft material is also malleable.

6. A system for use in the process of re-enforcing information presented in an interactive learning environment comprising:
at least two container members, each said member having an exterior surface;
a transparent material attached to the exterior surface of said container member;
at least one information card positioned in each said transparent member such that information contained on the card is displayed through said transparent material; and
a timing device to indicate the end of an activity session.

7. A method for use in the process of re-enforcing information presented in an interactive learning environment comprising the steps of:
inserting in each of a plurality of activity apparatuses a card containing information related to a particular subject matter;
establishing a time period for a learning activity that will use the activity apparatuses;
distributing the activity apparatuses to each student participating in the activity;
directing the students to review the information displayed on the cards inserted in each activity apparatus;
directing the students to pass the apparatus that they currently possess to another student participating in the activity; and
asking questions of the students related to the information that is displayed on the cards inserted into the plurality of activity apparatuses.

8. The method as described in claim 7 further comprising simultaneously with said student review step, the step of directing the students to recite a set information related to the subject matter of the information contained on the inserted cards.

9. The method as described in claim 7 further comprising the step of determining whether time has expired in this segment of the activity.
